(19) United States
(12) Patent Application Publication
(10) Pub. No.: US 2010/0043972 A1
(43) Pub. Date: Feb. 25, 2010

(54) APPARATUS FOR HARVESTING POLYCRYSTALLINE SILICON RODS AND METHODS OF USING THE SAME

(75) Inventors: Carlo Baldi, Merano (IT); Matteo Marsilio, Bolzano (IT); Pietro Scandola, Merano (IT)

Correspondence Address: MATTHIAS SCHOLL, 14781 MEMORIAL DRIVE, SUITE 1319, HOUSTON, TX, 77079, US

(73) Assignee: LDK Solar Hi-Tech Co., Ltd., Xinyu (CN)

(21) Appl. No.: 12/545,823

(22) Filed: Aug. 22, 2009

(30) Foreign Application Priority Data
Aug. 22, 2008 (CN) 200810107025.6

(51) Int. Cl. B29C 63/00; B05C 11/00

(52) U.S. Cl. 156/344; 118/70

(57) ABSTRACT

An apparatus for harvesting polycrystalline silicon rods, including at least: a wall comprising an inner wall, an outer wall and multiple wall connectors connecting the inner wall with the outer wall; a cavity formed between the inner wall and the outer wall; an access window formed in the outer wall; a base plate; and a plurality of contacts disposed on the base plate; wherein the inner wall and the outer wall are cylindrical and concentric; the cavity is adapted to receive a plurality of silicon rods resting on the contacts; and the access window is adapted to provide access to the silicon rods. The apparatus lowers the risks of contaminating the polycrystalline silicon rods during transfer and injuring the operator, and reduces time spent on transferring the polycrystalline silicon rods and the production time.

### CROSS-REFERENCE TO RELATED APPLICATIONS

Pursuant to 35 U.S.C. §119 and the Paris Convention Treaty, this application claims the benefit of Chinese Patent Application No. 200810107025.6 filed on Aug. 22, 2008, the contents of which are incorporated herein by reference in their entirety.

### BACKGROUND OF THE INVENTION

1. Field of the Invention

The invention relates to an improved apparatus for manufacturing polycrystalline silicon rods, and methods of using the same.

2. Description of the Related Art

Silicon materials have emerged as the cornerstone of modern electronics. Crystalline silicon, also called wafer silicon, is a material consisting of small silicon crystals. In single crystal silicon, also called monocrystal, the crystal lattice of the entire sample is continuous and unbroken with no grain boundaries. Polycrystalline silicon is a material consisting of multiple small silicon crystals.

High purity polycrystalline silicon is the basic raw material of the semiconductor and photovoltaic industries. Polycrystalline silicon can be as much as 99.9999999% pure. Ultra-pure poly is obtained by chemical or physical purification of metallurgical silicon.

In chemical purification, silicon is purified by converting it to a silicon compound that can be more easily purified than silicon itself, and then converting that silicon compound back into pure silicon. Trichlorosilane is the silicon compound most commonly used as the intermediate, although silicon tetrachloride and silane are also used. When these gases are blown over silicon at high temperature, they decompose to high-purity silicon. This process is termed chemical vapor deposition (CVD). The standard industry technique uses high purity silicon rods as the heated surface.

In more detail, in the CVD process, a silicon filament having a diameter of about 5-10 mm is heated to over 1100° C. in a polycrystalline silicon reduction furnace, then a high-purity gas containing silicon in an oxidized state and hydrogen gas are introduced, resulting in a silicon reduction reaction, and generating and depositing high purity silicon on the silicon filament. The silicon filament is allowed to grow until its diameter reaches between dozens and several hundreds of millimeters.

Following the CVD process, polycrystalline silicon rods are removed from the polycrystalline silicon reduction furnace and transferred to a next step in the production process. The removal and transfer are manual and comprise separating the cover of the polycrystalline silicon reduction furnace from the base plate, exposing the polycrystalline silicon rods to the environment, detaching a graphite chuck from the electrode on the base plate manually or via manipulators, removing the silicon rods pair by pair, and transporting the polycrystalline silicon rods to the next step.

Removing and transferring the rods from the reactor affects the quality of the polycrystalline silicon rods and the safety of the operators, and consumes a significant amount of production time:
(1) The polycrystalline silicon rods are exposed to the environment during transfer, which may cause contamination of the polycrystalline silicon rods by ions, CO₂, and other materials, which influences the quality of the polycrystalline silicon rods.
(2) The polycrystalline silicon rods are transferred one by one, and only one pair can be transferred at a time. Polycrystalline silicon hydrogen reactors normally fit 18-24 pairs of polycrystalline silicon rods, and therefore the operator has to repeat the transfer 18-24 times, which is labor intensive and takes a relatively long time.
(3) Since the cleaning of the base plate and starting a new batch can be conducted only after all polycrystalline silicon rods have been transferred from the base plate, transfer delays production.
(4) The polycrystalline silicon rods are very sharp and brittle; they are easy to be broken and may injure the operator during transfer.

### SUMMARY OF THE INVENTION

In view of the above-described problems, it is one objective of the invention to provide a harvest apparatus for harvesting polycrystalline silicon rods that features high safety, improved quality of the silicon rods, and reduced harvest time.

It is another objective of the invention to provide a method for harvesting polycrystalline silicon rods that features high safety, improved quality of the silicon rods, and reduced harvest time.

To achieve the above objective, in accordance with one embodiment of the invention, provided is an apparatus for harvesting polycrystalline silicon rods, comprising: a wall comprising an inner wall, an outer wall and multiple wall connectors connecting the inner wall with the outer wall; a cavity formed between the inner wall and the outer wall; an access window formed in the outer wall; a base plate; and a plurality of contacts disposed on the base plate; wherein the inner wall and the outer wall are cylindrical and concentric; the cavity is adapted to receive a plurality of silicon rods resting on the contacts; and the access window is adapted to provide access to the silicon rods.

In a class of this embodiment, the contacts are connected to the wall.

In another class of this embodiment, the apparatus further comprises a beam for lifting the wall connected to the apparatus by a beam connector.

In another class of this embodiment, a clamping device is connected to the wall.

In another class of this embodiment, the apparatus comprises further a guide rail for guiding the wall during lifting up and lowering down.

In another embodiment, provided is an apparatus for harvesting polycrystalline silicon rods, comprising: a first wall, a second wall, a third wall, a fourth wall, a fifth wall, and a sixth wall, and a plurality of wall connectors connecting the first wall with the second wall, the third wall with the fourth wall, and the fifth wall with the sixth wall; a first cavity formed between the first wall and the second wall; a second cavity formed between the third wall and the fourth wall, and a third cavity formed between the fifth wall and the sixth wall; a first access window formed in the first wall; a second access window formed in the third wall, and a third access window formed in the fifth wall; a base plate; and a plurality of contacts disposed on the base plate; wherein the first wall, the second wall, the third wall, the fourth wall, the fifth wall and the sixth wall are cylindrical and concentric; the first cavity, the second cavity, and the third cavity are adapted to receive a plurality of silicon rods resting on the contacts; the first access window, the second access window, and the third access window are adapted to provide access to the silicon rods; the sixth wall is cylindrical and enclosed by the fifth wall; the fifth wall is cylindrical and enclosed by the fourth wall; the fourth wall is cylindrical and enclosed by the third wall; the third wall is cylindrical and enclosed by the second wall; and the second wall is cylindrical and enclosed by the first wall; and the first wall, the second wall, the third wall, the fourth wall, the fifth wall, and the sixth wall are concentric.

In a class of this embodiment, the contacts are disposed on the first wall, the second wall, the third wall, the fourth wall, the fifth wall, and the sixth wall.

In a class of this embodiment, the apparatus comprises further a beam for lifting the first wall, the second wall, the third wall, the fourth wall, the fifth wall, and the sixth wall connected to the apparatus by a beam connector.

In a class of this embodiment, a clamping device is connected to the first wall.

In a class of this embodiment, the apparatus comprises further a guide rail for guiding the first wall during lifting up or lowering down.

In other aspects of the invention provided is a method for removing polycrystalline silicon rods from the apparatus described herein, comprising removing polycrystalline silicon rods from the first cavity; then; removing polycrystalline silicon rods from the second cavity; and then; removing polycrystalline silicon rods from the third cavity.

In a class of this embodiment, the method comprises further applying force to the polycrystalline silicon rods whereby detaching the rods from the base plate and allowing them to become loose within the first cavity, the second cavity, and the third cavity; and lifting up the first wall, the second wall, the third wall, and the fourth wall simultaneously.

In another class of this embodiment, the force is applied using a jumper hammer.

In another class of this embodiment, before removing the polycrystalline silicon rods, the rods are attached to the base plate via the contacts.

### BRIEF DESCRIPTION OF THE DRAWINGS

Detailed description of the invention will be given below with reference to accompanying drawings, in which:

FIG. 1 is a front schematic view of a harvest apparatus of the invention according to an exemplary embodiment;

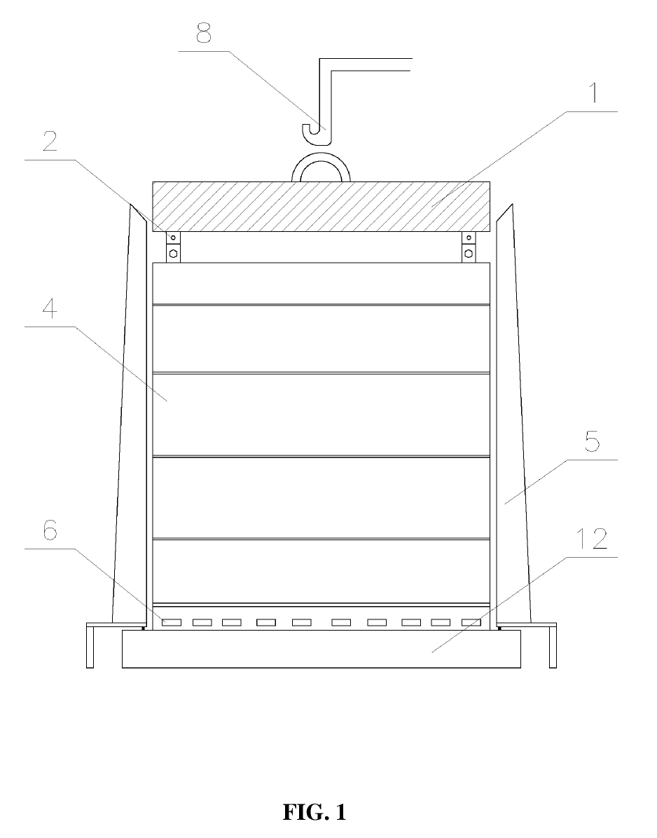

FIG. 2.is a top cross-sectional view thereof;

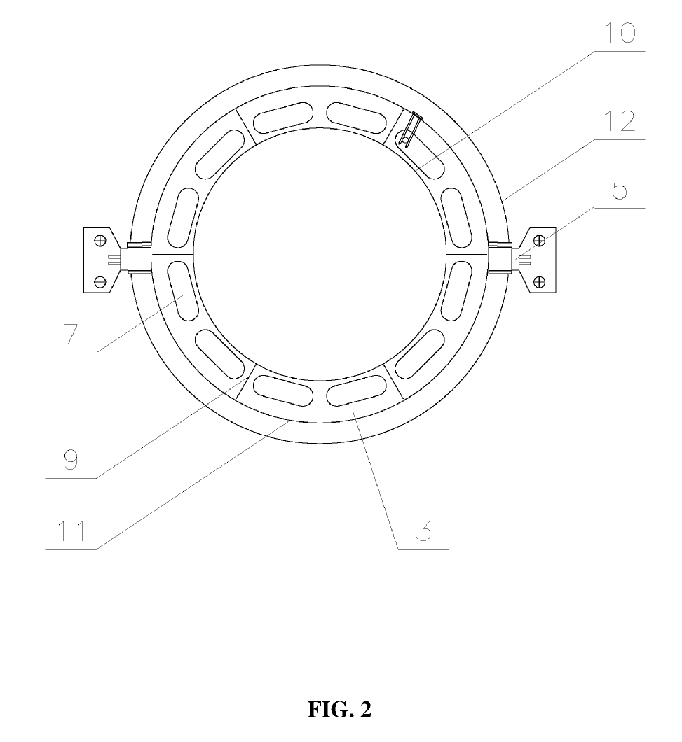

FIG. 3 is a schematic diagram illustrating removal of polycrystalline silicon rods from the harvest apparatus of the invention.

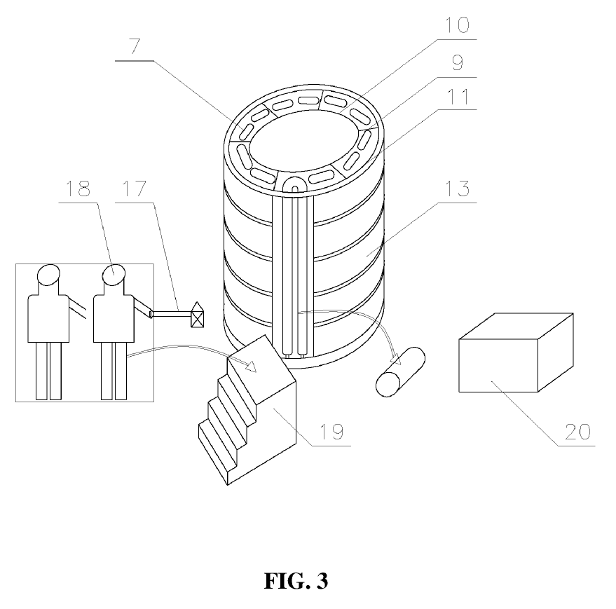

FIG. 4 is a front view of a harvest apparatus according to another exemplary embodiment of the invention; and

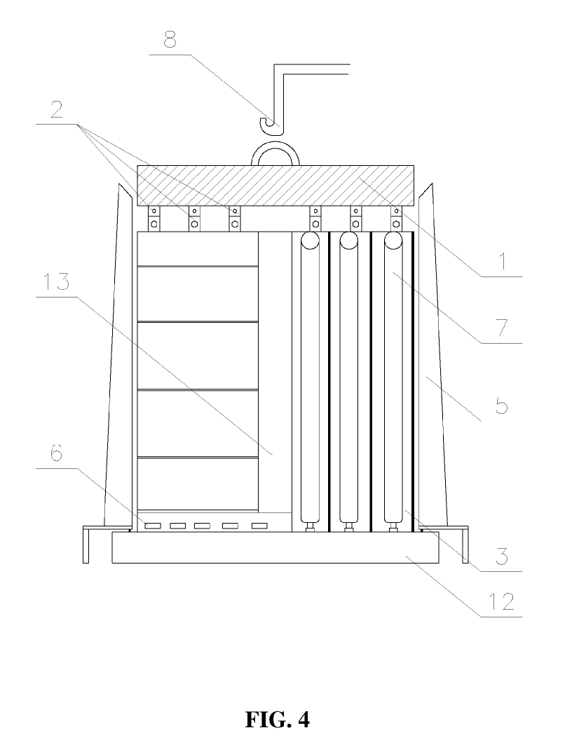

FIG. 5 is a top cross-sectional view thereof.

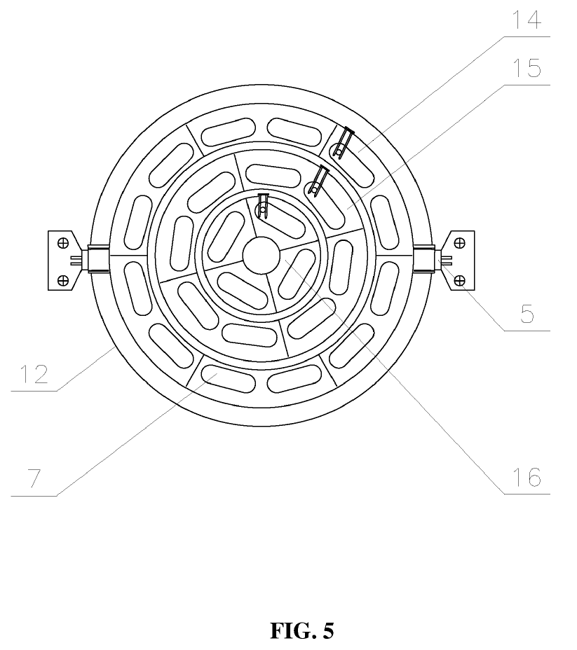

### DETAILED DESCRIPTION OF THE INVENTION

Polycrystalline silicon rods are circumferentially disposed on electrodes of a base plate for a polycrystalline silicon reduction furnace layer by layer (concentrically from the outside to the inside of the reactor). In certain embodiments, there are three layers. A conventional polycrystalline silicon reduction furnace is normally designed to have 24 pairs or 18 pairs of polycrystalline silicon rods. In order to make an apparatus according to this invention that would fit the same number of rods, e.g. 24 pairs, 12 pairs would be placed in the outer layer, 8 pairs in the middle layer, and 4 pairs in the inner layer.

A method for removing polycrystalline silicon rods of the invention comprises chemically vapor deposing multiple polycrystalline silicon rods 7 disposed on multiple concentric circular rings, then removing polycrystalline silicon rods 7 disposed on an outermost circular ring, then, removing polycrystalline silicon rods 7 disposed on a circular ring closely adjacent to the outermost circular ring, and repeating the above step from the outside to the inside of the reactor until all of the polycrystalline silicon rods 7 have been removed.

### EXAMPLE 1

In preparation for the CVD process, polycrystalline silicon rods 7 are attached to the base plate 12 while the wall 4 is lifted up by the crane 8. Contacts 6 are used to support the polycrystalline silicon rod 7. After the rods 7 have been mounted, the wall 4 is lowered into the base plate 4 and the rods 7 are enclosed each pair within a separate cavity 3 formed between the inner wall 10, the outer wall 11, and two adjacent wall connectors 9. When the rods are to be removed at the end of the CVD process, force is applied to contacts 6 to detach the polycrystalline silicon rod 7 from the base plate 12 at the contact position between the polycrystalline silicon rod 7 and the contact 6. The broken polycrystalline silicon rods 7 fall against the wall surrounding the cavity 3 of the harvest apparatus. Finally, the wall 4 of harvest apparatus is detached from the base plate 12 and lifted, and removal of multiple polycrystalline silicon rods 7 is completed.

In this example, the contact 6 is a plug-in module (e.g. a fork). By using the plug-in module to support the bottom of the polycrystalline silicon rod 7, a crane 8 disposed above the polycrystalline silicon rod 7 operates to detach the polycrystalline silicon rod 7 from the base plate 12 at a contact position between the polycrystalline silicon rod 7 and the contact 6. The separated polycrystalline silicon rod 7 is supported by the plug-in module and operates to support the polycrystalline silicon rod 7 that is detached from the base plate 12.

In this example, the above purpose can also be achieved by other types of contacts 6, namely, the contact 6 is used for detaching the polycrystalline silicon rod 7 from the base plate 12 and for supporting the detached polycrystalline silicon rod 7, so that the polycrystalline silicon rod 7 with large size is received in the cavity 3 of the harvest apparatus.

The polycrystalline silicon rods 7 disposed on the outermost circular ring of the base plate 12 are removed one by one; then polycrystalline silicon rods 7 disposed on a circular ring closely adjacent to the outermost circular ring are removed one by one; then polycrystalline silicon rods 7 disposed on the most inner circular ring are removed one by one. Alternatively, polycrystalline silicon rods 7 disposed on the outermost circular ring are removed group by group, each group formed by two adjacent pairs or three adjacent pairs of the removal polycrystalline silicon rods 7; then, polycrystalline silicon rods 7 disposed on a circular ring closely adjacent to the outermost circular ring are removed group by group; then, polycrystalline silicon rods 7 disposed on an inner circular ring are removed group by group.

### EXAMPLE 2

In preparation for the CVD process, polycrystalline silicon rods 7 are attached to the base plate 12 while the wall 4 is lifted up by the crane 8. Contacts 6 are used to support the polycrystalline silicon rod 7. After the rods 7 have been mounted, the wall 4 is lowered into the base plate 4 and the rods 7 are enclosed each pair within a separate cavity 3 formed between the inner wall 10, the outer wall 11, and two adjacent wall connectors 9. When the rods are to be removed at the end of the CVD process, a jumper hammer is used to break the polycrystalline silicon rod 7 and to detach the polycrystalline silicon rod 7 from the base plate 12. The jumper hammer is inserted through an access window 13 in the wall 4 of the harvest apparatus, and breaks a contact portion between the polycrystalline silicon rod 7 and the jumper hammer, so that the polycrystalline silicon rods 7 are detached from the base plate 12 and the polycrystalline silicon rod 7 falls against the wall 4 surrounding the cavity 3 of the harvest apparatus. Finally, the wall 4 of harvest apparatus is detached from the base plate 12 and lifted, and removal of multiple polycrystalline silicon rods 7 is completed.

Other devices, such as cutters, manipulators and so on, can be used to detach the polycrystalline silicon rod 7 from the base plate 12.

### EXAMPLE 3

A guide rail 5 is disposed on the edge of the base plate 12 whereby allowing the wall 4 to be raised and lowered more accurately so that the polycrystalline silicon rods 7 are not damaged in the process. Other features are the same as in the examples above.

### EXAMPLE 4

The polycrystalline silicon rods 7 are removed pair by pair. Other features are the same as in the examples above.

### EXAMPLE 5

The harvest apparatus comprises a wall 4, a plurality of cavities 3, and a plurality of contacts 6. Each cavity 3 is formed between the inner wall 10, the outer wall 11, and two adjacent wall connectors 9. The contact 6 is disposed at the bottom of the harvest apparatus. A plurality of holes is disposed at the bottom of the wall 4 and allows the contacts 6 to pass through.

The inner wall 10 and the outer wall 11 are cylindrical and concentric, and the wall connectors 9 are connected between the inner wall 10 and the outer wall 11.

In this example, the contacts 6 are disposed on the wall 4 of the harvest apparatus. The harvest apparatus further comprises a beam connector 2 and a beam 1, and the top of the harvest apparatus 14 is fixed to the beam 1 via the beam connector 2.

A clamping device is connected to the wall 4 of the harvest apparatus (not shown). In this example, the clamping device is disposed at the top and bottom of the harvest apparatus.

A access window 13 is disposed on the wall 4 of the harvest apparatus.

### EXAMPLE 6

A multi-layer harvest apparatus comprises an inner harvest apparatus 16, a middle harvest apparatus 15, and an outer harvest apparatus 14. Each of these are cylindrical and concentric but have different radiuses. The middle harvest apparatus 15 is disposed within the outer harvest apparatus 14, and the inner harvest apparatus 16 is disposed within the middle harvest apparatus 15.

### EXAMPLE 7

A multi-layer harvest apparatus comprises an inner harvest apparatus 16, a middle harvest apparatus 15, and an outer harvest apparatus 14. Each of these are cylindrical and concentric but have different radiuses. The middle harvest apparatus 15 is disposed within the outer harvest apparatus 14, and the inner harvest apparatus 16 is disposed within the middle harvest apparatus 15.

The top of each of the inner harvest apparatus 16, the middle harvest apparatus 15 and the outer harvest apparatus 14 is fixed to the beam 1 via beam connector 2, and the beam 1 is connected to a crane 8.

In this example, a method of detaching a polycrystalline silicon rods 7 from a base plate 12 for a polycrystalline silicon reduction furnace is as follows: force is applied to the polycrystalline silicon rod 7 via a contact so that it is detached from the base plate 12. Alternatively, force is applied to the polycrystalline silicon rod 7 via an external device so that it is detached from the base plate 12. Alternatively, the polycrystalline silicon rods 7 are detached from the base plate 12 one by one manually. Alternatively, the polycrystalline silicon rod 7 is detached from the base plate 12 by using a vertical or horizontal jumper hammer to break the polycrystalline silicon rod 7. Other devices such as a manual crowbar, a manual folk, a manual hammer, a mechanical jumper hammer, a mechanical gripper, a mechanical crowbar, a mechanical folk and so on can also be used to detach the polycrystalline silicon rod 7 from the base plate 12.

### EXAMPLE 8

Moreover, the following methods can be used to detach the polycrystalline silicon rod 7 from the base plate 12.

For example, the wall 4 may be turned until the access window 13 exposes a polycrystalline silicon rod 7. Then, manual crowbar 17 is inserted by an operator 18 standing on a ladder 19 through the access window 13 to detach the polycrystalline silicon rod 7 from the base plate 12. The polycrystalline rod is supported by the walls surrounding the cavity 3 and remains within the cavity 3 after it is detached from the base plate 12. Instead of the manual crowbar, a horizontal jumper hammer, or a suspended-type jumper hammer can be used.

### EXAMPLE 8

In order to keep the polycrystalline silicon rod 7 detached from the base plate 12 in the harvest apparatus, a component operating to support the polycrystalline silicon rod 7 is required. The contact 6 disposed at the bottom of the harvest apparatus can be used to implement this.

For example, the contact 6 is a movable bottom plate disposed at the bottom of the harvest apparatus. First, the movable bottom plate is folded so that is will not break the polycrystalline silicon rod 7, then a cavity 3 of the harvest apparatus supports the polycrystalline silicon rod 7 disposed on the base plate 12. After that, the movable bottom plate is unfolded so that the cavity 3 is separated from the base plate 12.

In this example, the movable bottom plate is formed by multiple sheets and capable of stretching, and does not occupy place when it is unfolded. The polycrystalline silicon rod 7 can be detached from the base plate 12 by passing the movable bottom plate through a hole on the wall 4 of the harvest apparatus and clamping (or fixing or supporting) the polycrystalline silicon rod 7. Since the cavity 3 is separated from the base plate 12, the polycrystalline silicon rod 7 detached from the base plate 12 is loose within the cavity 3. Thus, the movable bottom plate implements the function of supporting.

The contact 6 is a plug-in module disposed at the bottom of the harvest apparatus, such as a folk. The plug-in module passes through the wall 4 and prevents the polycrystalline silicon rod 7 detached from the base plate 12 from detaching from the cavity 3. The plug-in module also implements the function of supporting.

For example, the contact 6 is a meshwork passing through the cavity 3 from the top via a mechanical arm. The meshwork is fit onto the polycrystalline silicon rod 7 and has the function of supporting. One end of the meshwork is hanged on the harvest apparatus. Multiple holes are disposed at the bottom of the wall 4 and allow the contact 6 to pass through and to clamp the bottom of the polycrystalline silicon rod 7 without being blocked by the polycrystalline silicon rod 7 or separating blades.

### EXAMPLE 9

As the polycrystalline silicon rod 7 detached from the base plate 12 is separated from the base plate and is loose within the cavity 3 and is surrounded by the wall 4, the harvest apparatus is hoisted upwardly via the crane 8 and detached from the base plate 12, or detached from the base plate 12 by upwardly moving a clamping device surrounding the wall 4 via a mechanical arm.

Multiple polycrystalline silicon rods 7 are received in the cavity 3, and efficiency of transferring multiple polycrystalline silicon rods 7 at a time is far higher than that of a traditional method that can only transfer one polycrystalline silicon rod 7 or a pair of polycrystalline silicon rods 7 by one time. In addition, the wall 4 has the function of protection, and is capable of preventing risks of hurting an operator 18 during transferring and contaminating the polycrystalline silicon rod 7.

### EXAMPLE 10

The harvest apparatus with multiple polycrystalline silicon rods 7 is aligned with a truck 20 via the crane 8. Then, the movable bottom plate is slowly opened and the polycrystalline silicon rods 7 fall into the container of the truck 20. Finally, the truck 20 transports the polycrystalline silicon rods 7 to the next workshop.

Alternatively, the harvest apparatus with multiple polycrystalline silicon rods 7 is aligned with the bottom of a container of a truck 20 via the mechanical arm and the clamping device. Then the access window 13 is opened and the operator 18 takes out the polycrystalline silicon rods 7 from the access window 13 and loads them onto the truck 20. Finally, the truck 20 transports the polycrystalline silicon rods 7 to the next workshop.

Alternatively, the harvest apparatus with multiple polycrystalline silicon rods 7 is put on a rotatable sheet, and the operator 18 takes out the polycrystalline silicon rods 7 from the access window 13, and rotates wall 4 intermittently to align the access window with additional rods. The operator loads the rods onto truck 20. Finally, the truck 20 transports the polycrystalline silicon rods 7 to the next workshop.

The operator 18 is capable of using hammer 17, standing on the ladder 19 and performing various additional auxiliary tasks.

The above-mentioned tasks of detaching the polycrystalline silicon rod 7 from the base plate 12, and supporting, and transferring the rods are independent from each other and different embodiments of each of the steps can be mixed and matched.

It should be noted that the harvest apparatus and the method using the same in this invention are not limited to polycrystalline silicon rods 7 that are circularly arranged, and can be applied to polycrystalline silicon rods 7 that are arranged in linear arrays or in other layouts, as long as the wall 4 has a shape suitable for these polycrystalline silicon rods 7.

This invention has the following advantages:
(1) During harvest, the polycrystalline silicon rods are protected in a harvest apparatus chamber, which prevents a risk of contaminating the polycrystalline silicon rods during a transferring process.
(2) Multiple polycrystalline silicon rods can be transferred to the next production process all at one time, whereby improving production efficiency.
(3) Time spent on transferring the polycrystalline silicon rods is decreased, and thus a production period thereof is reduced.
(4) The risk of injury to the operator by the polycrystalline silicon rods is prevented since the harvest is largely automated.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An apparatus for harvesting polycrystalline silicon rods, comprising:
a wall comprising an inner wall, an outer wall and multiple wall connectors connecting said inner wall with said outer wall;
a cavity formed between said inner wall and said outer wall;
a access window formed in said outer wall;
a base plate; and
a plurality of contacts disposed on said base plate;
wherein
said inner wall and said outer wall are cylindrical and concentric;
said cavity is adapted to receive a plurality of silicon rods resting on said contacts; and
said access window is adapted to provide access to the silicon rods.

2. The apparatus of claim 1, wherein said contacts are connected to said wall.

3. The apparatus of claim 1, further comprising a beam for lifting said wall connected to the apparatus by a beam connector.

4. The apparatus of claim 1, wherein a clamping device is connected to said wall.

5. The apparatus of claim 1, comprising further a guide rail for guiding said wall during lifting up and lowering down.

6. An apparatus for harvesting polycrystalline silicon rods, comprising:
a first wall, a second wall, a third wall, a fourth wall, a fifth wall, and a sixth wall, and a plurality of wall connectors connecting said first wall with said second wall, said third wall with said fourth wall, and said fifth wall with said sixth wall;
a first cavity formed between said first wall and said second wall; a second cavity formed between said third wall and said fourth wall, and a third cavity formed between said fifth wall and said sixth wall;
a first access window formed in said first wall; a second access window formed in said third wall, and a third access window formed in said fifth wall;
a base plate; and
a plurality of contacts disposed on said base plate;
wherein
said first wall, said second wall, said third wall, said fourth wall, said fifth wall, and said sixth wall are cylindrical and concentric;
said first cavity, said second cavity, and said third cavity are adapted to receive a plurality of silicon rods resting on said contacts;
said first access window, said second access window, and said third access window are adapted to provide access to the silicon rods;
said sixth wall is cylindrical and enclosed by said fifth wall; said fifth wall is cylindrical and enclosed by said fourth wall, said fourth wall is cylindrical and enclosed by said third wall; said third wall is cylindrical and enclosed by said second wall; and said second wall is cylindrical and enclosed by said first wall; and
said first wall, said second wall, said third wall, said fourth wall, said fifth wall, and said sixth wall are concentric.

7. The apparatus of claim 6, wherein said contacts are disposed on said first wall, said second wall, said third wall, said fourth wall, said fifth wall, and said sixth wall.

8. The apparatus of claim 6, comprising further a beam for lifting said first wall, said second wall, said third wall, said fourth wall, said fifth wall, and said sixth wall connected to the apparatus by a beam connector.

9. The apparatus of claim 6, wherein a clamping device is connected to said first wall.

10. The apparatus of claim 6, comprising further a guide rail for guiding said first wall during lift up.

11. A method for removing polycrystalline silicon rods from the apparatus of claim 6, comprising
removing polycrystalline silicon rods from said first cavity;
then; removing polycrystalline silicon rods from said second cavity; and
then; removing polycrystalline silicon rods from said third cavity.

12. The method of claim 11, further comprising
applying force to the polycrystalline silicon rods whereby detaching the rods from the base plate and allowing them to become loose within said first cavity, said second cavity, and said third cavity.
lifting up said first wall, said second wall, said third wall, and said fourth wall simultaneously.

13. The method of claim 11, wherein said force is applied using a jumper hammer.

14. The method of claim 11, wherein before removing the polycrystalline silicon rods, the rods are attached to said base plate via said contacts.
